(19) United States
(12) Patent Application Publication
(10) Pub. No.: US 2023/0093263 A1
(43) Pub. Date: Mar. 23, 2023

(54) METHOD AND APPARATUS FOR DETECTING HUMAN BODY AROUND GAME TABLE, ELECTRONIC DEVICE AND STORAGE MEDIUM

(71) Applicant: SENSETIME INTERNATIONAL PTE. LTD., Singapore (SG)

(72) Inventors: Zhongang CAI, Singapore (SG); Daxuan REN, Singapore (SG); Zhipeng LUO, Singapore (SG); Haiyu ZHAO, Singapore (SG)

(21) Appl. No.: 17/489,021

(22) Filed: Sep. 29, 2021

Related U.S. Application Data
(63) Continuation of application No. PCT/IB2021/058765, filed on Sep. 27, 2021.

(30) Foreign Application Priority Data
Sep. 22, 2021 (SG) 10202110486W

(51) Int. Cl. G06K 9/00; A63F 11/00; G06T 7/50; G06K 9/62

(52) U.S. Cl. CPC G06K 9/00362; A63F 11/00; G06K 9/00624; G06T 7/50; G06K 9/6289; G06T 2207/10028; G06T 2207/30196

(57) ABSTRACT

Provided are a method and apparatus for detecting a human body around a game table, an electronic device and a storage medium. The method includes that: three-dimensional scene data of the game table collected by at least one three-dimensional sensor arranged around the game table is acquired; human body detection information around the game table is acquired, wherein the human body detection information includes detection information of at least one human body; and the human body detection information is filtered based on the three-dimensional scene data to obtain a human body detection result around the game table.

### CROSS-REFERENCE TO RELATED APPLICATION(S)

The application is continuation of international application PCT/IB2021/058765 filed on 27 Sep. 2021, which claims priority to Singaporean patent application No. 10202110486W filed with IPOS on 22 Sep. 2021. The contents of international application PCT/IB2021/058765 and Singaporean patent application No. 10202110486W are incorporated herein by reference in their entireties.

### TECHNICAL FIELD

The disclosure relates to the technical field of computer vision, and more particularly, to a method and apparatus for detecting a human body around a game table, an electronic device and a storage medium.

### BACKGROUND

For a game scene, one or more cameras are usually arranged around a game table to realize acquisition of two-dimensional images of the scene.

At present, human body detection processing may be carried out on the two-dimensional images collected by the cameras, so that human body detection results around the game table are obtained, the human body detection results all depend on the two-dimensional images, while noise often exists in the two-dimensional images, so that the accuracy and effectiveness of the human body detection results are low.

### SUMMARY

Embodiments of the disclosure are intended to provide a method and apparatus for detecting a human body around a game table, an electronic device and a storage medium.

The embodiments of the disclosure provide a method for detecting a human body around a game table, which includes the following operations.

Three-dimensional scene data of the game table collected by at least one three-dimensional sensor arranged around the game table is acquired.

Human body detection information around the game table is acquired, where the human body detection information includes detection information of at least one human body.

The human body detection information is filtered based on the three-dimensional scene data to obtain a human body detection result around the game table.

In the above method, the operation that the human body detection information is filtered based on the three-dimensional scene data to obtain the human body detection result around the game table includes the following operations.

The distance between each detected human body in the human body detection information and the game table is determined based on the three-dimensional scene data.

The human body detection information at a distance exceeding a set threshold value from the game table in the human body detection information is filtered to obtain the human body detection result around the game table.

In the above method, the operation that the human body detection information around the game table is acquired includes the following operations.

Two-dimensional image data of the game table collected by at least one two-dimensional image sensor arranged around the game table is acquired.

The human body around the game table is detected based on the two-dimensional image data to obtain two-dimensional human body detection information around the game table.

In the above method, the number of the three-dimensional sensor arranged round the game table is 1, and the three-dimensional scene data includes depth information.

The operation that the distance between each detected human body in the human body detection information and the game table is determined based on the three-dimensional scene data includes the following operations.

Depth information of the game table and each human body in the two-dimensional human body detection information is determined based on the three-dimensional scene data.

The distance between each human body in the human body detection information and the game table is determined based on the depth information.

In the above method, at least one three-dimensional sensor refers to a plurality of three-dimensional sensors, and the plurality of three-dimensional sensors is distributed at a plurality of different orientations around the game table.

The method further includes the following operation.

Complete three-dimensional data of the game table is constructed based on the three-dimensional scene data of the game table collected by each three-dimensional sensor in the plurality of three-dimensional sensors.

The operation that human body detection information around the game table is acquired includes the following operation.

Human body detection is carried out based on the complete three-dimensional data of the game table to obtain three-dimensional human body detection information around the game table.

The method further includes the following operations.

Game prop detection is carried out based on the complete three-dimensional data to obtain three-dimensional detection information of a game prop on the game table.

An operation relationship between the human body and the game prop is determined based on the three-dimensional detection information of the game prop and the three-dimensional human body detection information.

The method further includes the following operations.

Two-dimensional image data of the game table collected by at least one two-dimensional image sensor arranged around the game table is acquired.

The human body around the game table and the game prop on the game table are detected based on the two-dimensional image data to obtain two-dimensional human body detection information around the game table and two-dimensional detection information of the game prop on the game table.

In the above method, the operation that the operation relationship between the human body and the game prop is determined based on the three-dimensional detection information of the game prop and the three-dimensional human body detection information include the following operations.

The two-dimensional human body detection information and the three-dimensional human body detection information are fused to obtain multi-mode human body detection information.

The two-dimensional detection information and the three-dimensional detection information of the game prop are fused to obtain multi-mode detection information of the game prop.

The operation relationship between the human body and the game prop is determined based on the multi-mode human body detection information and the multi-mode detection information of the game prop.

In the above method, the operation that the operation relationship between the human body and the game props is determined based on the three-dimensional detection information of the game prop and the three-dimensional human body detection information include the following operations.

A first operation relationship between the human body and the game prop in a two-dimensional plane is determined based on the two-dimensional human body detection information and the two-dimensional detection information of the game prop.

A second operation relationship between the human body and the game prop in a three-dimensional space is determined based on the three-dimensional human body detection information and the three-dimensional detection information of the game prop.

The first operation relationship and the second operation relationship are fused to obtain an operation relationship between the human body and the game prop.

The embodiments of the disclosure provide an apparatus for detecting a human body around a game table, which includes an acquisition module and a detection module.

The acquisition module is configured to acquire three-dimensional scene data of the game table collected by at least one three-dimensional sensor arranged around the game table, and acquire human body detection information around the game table, where the human body detection information includes detection information of at least one human body.

The detection module is configured to filter the human body detection information based on the three-dimensional scene data to obtain a human body detection result around the game table.

In the above apparatus, the detection module is specifically configured to determine the distance between each detected human body in the human body detection information and the game table based on the three-dimensional scene data, and filter the human body detection information at a distance exceeding a set threshold value from the game table in the human body detection information to obtain the human body detection result around the game table.

In the above apparatus, the acquisition module is specifically configured to acquire two-dimensional image data of the game table collected by at least one two-dimensional image sensor arranged around the game table, and detect the human body around the game table based on the two-dimensional image data to obtain two-dimensional human body detection information around the game table.

In the above apparatus, the number of the three-dimensional sensor arranged round the game table is 1, and the three-dimensional scene data includes depth information.

The detection module is specifically configured to determine depth information of the game table and each human body in the two-dimensional human body detection information based on the three-dimensional scene data, and determine the distance between each human body in the two-dimensional human body detection information and the game table based on the depth information.

The apparatus further includes a construction module, the at least one three-dimensional sensor refers to a plurality of three-dimensional sensors, and the plurality of three-dimensional sensors is distributed at a plurality of different orientations around the game table.

The construction module is configured to construct complete three-dimensional data of the game table based on the three-dimensional scene data of the game table collected by each three-dimensional sensor in the plurality of three-dimensional sensors.

The acquisition module is specifically configured to carry out human body detection based on the complete three-dimensional data of the game table to obtain three-dimensional human body detection information around the game table.

In the above apparatus, the detection module is further configured to carry out game prop detection based on the complete three-dimensional data to obtain three-dimensional detection information of a game prop on the game table, and determine an operation relationship between the human body and the game prop based on the three-dimensional detection information of the game prop and the three-dimensional human body detection information.

In the above apparatus, the acquisition module is further configured to acquire two-dimensional image data of the game table collected by at least one two-dimensional image sensor arranged around the game table.

The detection module is further configured to detect the human body around the game table and the game prop on the game table based on the two-dimensional image data to obtain two-dimensional human body detection information around the game table and two-dimensional detection information of the game prop on the game table.

The embodiments of the disclosure provide an electronic device, which includes a first processor and a first memory. The first memory stores a computer program executable on the first processor. When the first processor executes the program, the method for detecting a human body around a game table is implemented.

The embodiments of the disclosure provide a system for detecting a human body around a game table, which includes a second processor, a second memory, and at least one three-dimensional sensor arranged around the game table.

The at least one three-dimensional sensor is configured to collect three-dimensional scene data of the game table.

The second processor is configured to execute one or more programs stored in the second memory, to implement the following steps: human body detection information around the game table is acquired, where the human body detection information includes detection information of at least one human body; and the human body detection information is filtered based on the three-dimensional scene data to obtain a human body detection result around the game table.

The system further includes at least one two-dimensional image sensor arranged around the game table.

The at least one two-dimensional image sensor is configured to collect two-dimensional image data of the game table.

The second processor is specifically configured to detect the human body around the game table based on the two-dimensional image data to obtain two-dimensional human body detection information around the game table.

The embodiments of the disclosure provide a computer-readable storage medium, storing one or more programs. The one or more programs may be executed by one or more processors, to implement the method for detecting a human body around a game table.

The embodiments of the disclosure provide the method and apparatus for detecting a human body around a game table, the electronic device and the storage medium. The method includes that: three-dimensional scene data of the game table collected by at least one three-dimensional sensor arranged around the game table is acquired; human body detection information around the game table is acquired, where the human body detection information includes detection information of at least one human body; and the human body detection information is filtered based on the three-dimensional scene data to obtain the human body detection result around the game table. According to the embodiments of the disclosure, the three-dimensional scene data of the game table in a game scene is acquired by using the three-dimensional sensor, and the human body detection information around the game table is filtered, so that the accurate and effective human body detection result is obtained.

### BRIEF DESCRIPTION OF THE DRAWINGS

FIG. 1 illustrates a flowchart schematic diagram a method for detecting a human body around a game table provided by an embodiment of the disclosure.

FIG. 2 illustrates a deployment schematic diagram I of an exemplary three-dimensional sensor provided by an embodiment of the disclosure.

FIG. 3 illustrates a deployment schematic diagram II of an exemplary three-dimensional sensor provided by an embodiment of the disclosure.

FIG. 4 illustrates a deployment schematic diagram III of an exemplary three-dimensional sensor provided by an embodiment of the disclosure.

FIG. 5 illustrates a structural schematic diagram an apparatus for detecting a human body around a game table provided by an embodiment of the disclosure.

FIG. 6 illustrates a structural schematic diagram of an electronic device provided by an embodiment of the disclosure.

FIG. 7 illustrates a structural schematic diagram of a system for detecting a human body around a game table provided by an embodiment of the disclosure.

### DETAILED DESCRIPTION

The embodiments of the disclosure provide a method for detecting a human body around a game table. The execution main body may be an apparatus for detecting a human body around a game table. For example, the method for detecting a human body around a game table may be executed by a terminal device or a server or other electronic devices. The terminal device may be User Equipment (UE), a mobile device, a user terminal, a terminal, a cell phone, a cordless phone, a Personal Digital Assistant (PDA), a handheld device, a computing device, a vehicle-mounted device, a wearable device, etc. In some possible implementation modes, the method for detecting a human body around a game table may be implemented by enabling a processor to call a computer-readable instruction stored in a memory.

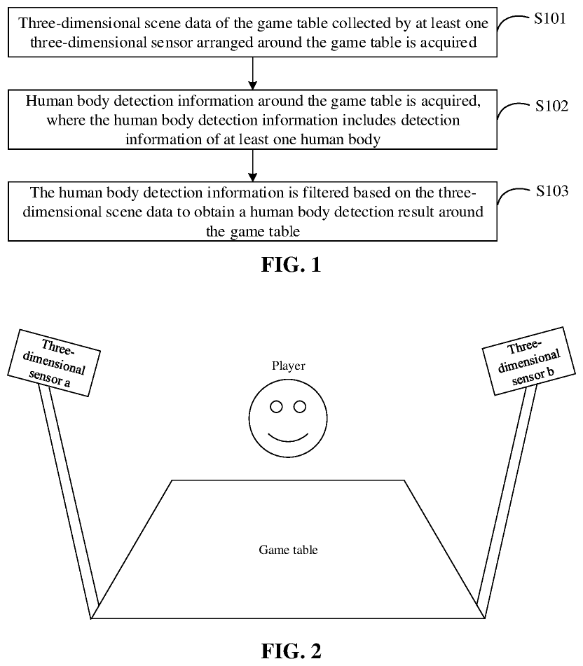

FIG. 1 illustrates a flowchart schematic diagram a method for detecting a human body around a game table provided by an embodiment of the disclosure. As shown in FIG. 1, the method for detecting a human body around a game table mainly includes the following steps.

In S101, three-dimensional scene data of the game table collected by at least one three-dimensional sensor arranged around the game table is acquired.

In the embodiment of the disclosure, an apparatus for detecting a human body may acquire the three-dimensional scene data of the game table collected by at least one three-dimensional sensor arranged around the game table.

It is to be noted that, in the embodiment of the disclosure, at least one three-dimensional sensor may be arranged around the game table. Specifically, the number of the specific three-dimensional sensor and the position of the three-dimensional sensor arranged round the game table may be set according to actual requirements, and are not limited by the embodiment of the disclosure.

It is to be noted that, in the embodiment of the disclosure, the three-dimensional sensor is a sensor supporting acquisition of complete three-dimensional data; the three-dimensional sensor may specifically be a laser radar, a depth camera or the like, which is not limited by the embodiment of the disclosure.

It is to be understood that, in some embodiments of the disclosure, in a case that one three-dimensional sensor is arranged around the game table, in the sensing range of the three-dimensional sensor, actually, three-dimensional scene data of the game table may only be collected from one orientation around the game table, i.e., the three-dimensional scene data acquired by some embodiments of the disclosure is the three-dimensional scene data of one view angle around the game table. In a case that a plurality of three-dimensional sensors are arranged round the game table and distributed at a plurality of different orientations of the game table, the sensing range of each three-dimensional sensor may cover the game table and a part of area round the game table, each three-dimensional sensor may acquire three-dimensional scene data of one view angle of the game table, and the three-dimensional scene data of multiple view angles are spiced to obtain the three-dimensional scene data of the whole game table.

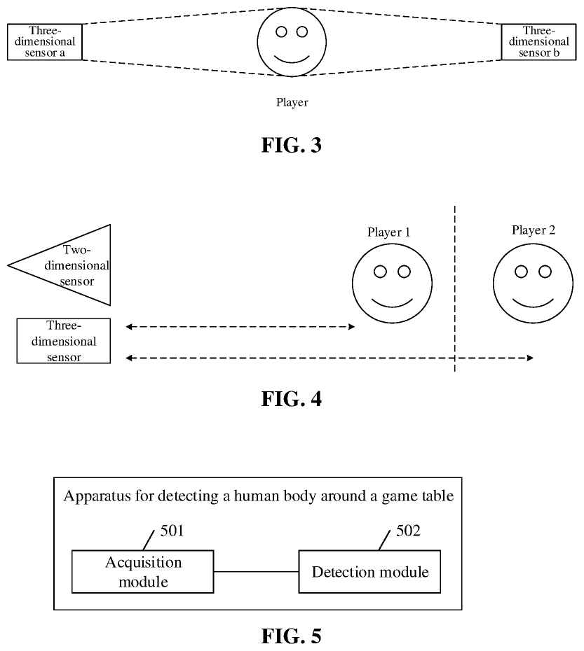

FIG. 2 illustrates a deployment schematic diagram I of an exemplary three-dimensional sensor provided by an embodiment of the disclosure. FIG. 3 illustrates a deployment schematic diagram II of an exemplary three-dimensional sensor provided by an embodiment of the disclosure. As shown in FIGS. 2 and 3, in an embodiment of the disclosure, two three-dimensional sensors, namely, a three-dimensional sensor a and a three-dimensional sensor b, are arranged around the game table, and the two three-dimensional sensors are arranged on two parallel sides of the game table, and may sense information of the game table and a human body around the game table in two orientations as three-dimensional scene data.

In S102, human body detection information around the game table is acquired, where the human body detection information includes detection information of at least one human body.

In the embodiment of the disclosure, the apparatus for detecting a human body may acquire the three-dimensional scene data of the game table, and may also acquire the human body detection information around the game table, and the human body detection information includes the detection information of at least one human body. The detection information specifically may include information such as location and/or attributes.

It is to be noted that, in the embodiment of the disclosure, the apparatus for detecting a human body acquires the human body detection information around the game table, two-dimensional human body detection information around the game table may be acquired, or three-dimensional human body detection information around the game table may be acquired, which is not limited by the embodiment of the disclosure. The two-dimensional human body detection information and the three-dimensional human body detection information may be acquired by carrying out human body detection on two-dimensional images and three-dimensional data around the game table respectively.

In an embodiment, the step that the human body detection information around the game table is acquired includes the following steps: two-dimensional image data of the game table collected by at least one two-dimensional image sensor arranged around the game table is acquired; and the human body around the game table is detected based on the two-dimensional image data to obtain the two-dimensional human body detection information around the game table.

It is to be noted that, in the embodiment of the disclosure, at least one two-dimensional image sensor may be arranged around the game table and configured to collect the two-dimensional image data of the game table. In this way, the apparatus for detecting a human body may acquire the two-dimensional image data of the game table through communication interaction with the at least one two-dimensional image sensor. Further, human body detection around the game table is carried out by adopting a human body detecting algorithm aiming at the image data based on the two-dimensional image data, and thus the two-dimensional human body detection information around the game table is obtained. Specifically, the number and position of the two-dimensional image sensor are not limited by the embodiment of the disclosure.

In an embodiment, at least one three-dimensional sensor refers to a plurality of three-dimensional sensors, the plurality of three-dimensional sensors is distributed at a plurality of different orientations around the game table, and the apparatus for detecting a human body may perform the following steps. Complete three-dimensional data of the game table is constructed based on the three-dimensional scene data of the game table collected by each three-dimensional sensor in the plurality of three-dimensional sensors. The step that the apparatus for detecting a human body acquires the human body detection information around the game table include the following step: human body detection is carried out based on the complete three-dimensional data of the game table to obtain three-dimensional human body detection information around the game table.

It is to be noted that, in a case that a plurality of three-dimensional sensors is arranged around the game table and the plurality of three-dimensional sensors is distributed at a plurality of different orientations around the game table, the apparatus for detecting a human body may also fuse the three-dimensional scene data of the game table collected by different three-dimensional sensors, so as to construct complete three-dimensional data around the game table which is free of shielding, complete in view and complete in information. Here, the complete three-dimensional data may be three-dimensional point cloud data.

It is to be understood that, in the embodiment of the disclosure, in a case that complete three-dimensional data of the game table is constructed, human body detection may be carried out on the complete three-dimensional data of the game table by adopting a human body detecting algorithm for the complete three-dimensional data, so as to obtain the three-dimensional human body detection information around the game table. Compared with the two-dimensional human body detection information around the game table, the three-dimensional human body detection information further includes depth information of the detected human body, that is, the information content is richer.

In the embodiment of the disclosure, in a case that the three-dimensional human body detection information around the game table is obtained, the apparatus for detecting a human body also performs the following steps: game prop detection is carried out based on the complete three-dimensional data to obtain three-dimensional detection information of a game prop on the game table; and an operation relationship between the human body and the game prop is determined based on the three-dimensional detection information of the game prop and the three-dimensional human body detection information.

It is to be understood that, in the embodiment of the disclosure, the complete three-dimensional data of the game table includes related information of game props on the game table, so that the apparatus for detecting a human body may detect the game props based on the complete three-dimensional data to obtain the three-dimensional detection information of the game props. Therefore, under the condition that the human body detection information is the three-dimensional human body detection information, the operation relationship between the human body and the game props is determined based on the three-dimensional detection information of the game props and the three-dimensional human body detection information, namely, the association between the human body and the game props is realized. The apparatus for detecting a human body determines the operation relationship between the human body and the game props, specifically, match the depth information of the game props in the three-dimensional detection information of the game props with the depth information of the human body in the three-dimensional human body detection information .Of course, the operation may also be realized based on other algorithms, which is not limited by the embodiment of the disclosure.

It is to be understood that, in the embodiment of the disclosure, because the complete three-dimensional data contains dense and complete information and has a wide coverage range, the human body detection and game prop detection based on the complete three-dimensional data can overcome shielding, incomplete visual field and incomplete information, and thus the detection accuracy is improved.

In some embodiments, the following steps may also be performed: two-dimensional image data of the game table collected by at least one two-dimensional image sensor arranged around the game table is acquired; and the human body around the game table and the game prop on the game table are detected based on the two-dimensional image data to obtain two-dimensional human body detection information around the game table and two-dimensional detection information of the game prop on the game table.

It is to be noted that, in the embodiment of the disclosure, at least one two-dimensional image sensor arranged around the game table may collect the two-dimensional image data of the game table, and the apparatus for detecting a human body may detect the human body around the game table based on the two-dimensional image data to obtain the two-dimensional human body detection information around the game table, and may also detect the game props on the game table to obtain the two-dimensional detection information of the game props.

It is to be understood that, in the embodiment of the disclosure, for the apparatus for detecting a human body, if only three-dimensional scene data of the game table is acquired, human body detection information and detection information of game props obtained based on the three-dimensional scene data are three-dimensional data, and if two-dimensional image data of the game table is also obtained, the human body detection information and the detection information of the game props obtained based on the two-dimensional image data are two-dimensional data, which is not limited by the embodiment of the disclosure.

It is to be understood that, in the embodiment of the disclosure, under the condition that the apparatus for detecting a human body obtains the two-dimensional human body detection information and the two-dimensional detection information of the game props, in the process that the apparatus for detecting a human body determines the operation relation between the human body and the game props based on the three-dimensional detection information of the game props and the three-dimensional human body detection information, the determination of the operational relationship may be carried out in different ways in combination with the two-dimensional human body detection information and the two-dimensional detection information of the game props, the details will be described below.

Specifically, in the embodiment of the disclosure, under the condition that the apparatus for detecting a human body obtains the two-dimensional human body detection information and the two-dimensional detection information of the game props, the step that the apparatus for detecting a human body determines the operation relation between the human body and the game props based on the three-dimensional detection information of the game props and the three-dimensional human body detection information include the following steps: the two-dimensional human body detection information and the three-dimensional human body detection information are fused to obtain multi-mode human body detection information; the two-dimensional detection information and the three-dimensional detection information of the game props are fused to obtain multi-mode detection information of the game props; and based on the multi-mode human body detection information and the multi-mode detection information of the game props, the operation relationship between the human body and the game props is determined. The fusing mode of the two-dimensional human body detection information and the three-dimensional human body detection information may include but is not limited to one of: combination, splicing, weighted fusion, or selection according to credibility.

It is to be understood that, in the embodiment of the disclosure, for the human body and game props, corresponding two-dimensional detection information and three-dimensional detection information are fused, and the obtained multi-modal human body detection information and multi-modal detection information of the game props are rich in data type and data volume, so that when the multi-modal human body detection information and multi-modal detection information of the game props are adopted for detecting the operation relationship between the human body and the game props, the accuracy is high.

Specifically, in the embodiment of the disclosure, under the condition that the apparatus for detecting a human body obtains the two-dimensional human body detection information and the two-dimensional detection information of the game props, the step that the apparatus for detecting a human body determines the operation relation between the human body and the game props based on the three-dimensional detection information of the game props and the three-dimensional human body detection information may further include the following steps: based on the two-dimensional human body detection information and the two-dimensional detection information of the game props, a first operation relationship between the human body and the game props in a two-dimensional plane is determined; based on the three-dimensional human body detection information and the three-dimensional detection information of the game props, a second operation relationship between the human body and the game props in a three-dimensional space is determined; and the first operation relationship and the second operation relationship are fused to obtain the operation relationship between the human body and the game props.

The operation relationship between the human body and the game props is used for representing whether the human body performs operation on the game props or not and/or specific operation performed by the human body on the game props. In a game scene, the human body may perform the operations including taking away, putting down, moving positions and the like on the game props. By analyzing the operation relationship between the human body and the game props, the game behavior may be automatically monitored, and thus the analysis and monitoring for the game process are realized.

It is to be understood that, in the embodiment of the disclosure, the first operation relationship and the second operation relationship determined by the apparatus for detecting a human body are actually the operation relationships between the human body and the game props determined in different dimensions, the apparatus for detecting a human body fuses the operation relationships obtained in different dimensions, and the obtained operation relationship may reflect the operation relationship between the human body and the game props more accurately and completely.

In S103, the human body detection information is filtered based on the three-dimensional scene data to obtain a human body detection result around the game table.

In the embodiment of the disclosure, under the condition that three-dimensional scene data of the game table and human body detection information around the game table are obtained, the apparatus for detecting a human body filters out human bodies with small relevance with the game table, for example, the relative position between the detected human body and the game table may be analyzed and detected through the three-dimensional scene data, and the closer the relative position is, the larger the relevance is, or whether the human body detected in the three-dimensional space is overlapped with the desktop or not may be analyzed according to the three-dimensional scene data, and if the human body is not overlapped with the desktop, the corresponding human body is filtered out. Therefore, the human body detection information may be filtered based on the three-dimensional scene data to obtain a detection result of the human body (with high likelihood of the person participating in the game) around the game table.

Specifically, in some embodiments of the disclosure, the step that the apparatus for detecting a human body filters the human body detection information based on the three-dimensional scene data to obtain a human body detection result around the game table, includes the following steps that: the distance between each detected human body in the human body detection information and the game table is determined based on the three-dimensional scene data; and the human body detection information at a distance exceeding a set threshold value from the game table in the human body detection information is filtered to obtain the human body detection result around the game table.

In some embodiments, the three-dimensional scene data may include depth information. In addition, as described in S102, the human detection information around the game table acquired by the apparatus for detecting a human body may be two-dimensional human detection information, under the condition that the number of three-dimensional sensor arranged around the game table is 1, the apparatus for detecting a human body may determine depth information of the game table and each human body in the two-dimensional human body detection information based on the three-dimensional scene data, and determine the distance between each human body in the two-dimensional human body detection information and the game table based on the depth information.

It is to be understood, the three-dimensional scene data may include depth information, so that the apparatus for detecting a human body may match each human body in the two-dimensional human body detection information with the three-dimensional scene data, and corresponding depth information is determined. In addition, the depth information of the game table may also be determined in the three-dimensional scene data, therefore, the distance between each human body in the two-dimensional human body detection information and the game table may be obtained in combination with the depth information of each human body in the two-dimensional human body detection information.

In some embodiments, the three-dimensional scene data includes information of three spatial dimensions round the game table, including, for example, three-dimensional coordinate information of the human body around the table, the game table, and objects on the game table. The distance between the human body and the game table may be calculated according to the three-dimensional coordinate information of the human body and the three-dimensional coordinate information of the game table. The distance calculated through the spatial three-dimensional coordinates is more accurate, so that a more accurate filtering result of the human body detection information may be obtained.

It is to be understood, in the embodiment of the disclosure, the two-dimensional human body detection information reflects related information of the human body in a two-dimensional plane, which includes information of all detected human bodies at different distances from the game table, the information of the human body away from the game table is often not of interest to a user and does not need attention. Therefore, the apparatus for detecting a human body may determine the distance between each detected human body and the game table by means of the three-dimensional scene data, so that the detection information of the human body with a large distance from the game table is filtered from the human body detection information, the detection information with the distance from the game table not exceeding a set threshold value is selected, and an accurate and effective human body detection result is obtained.

FIG. 4 illustrates a deployment schematic diagram III of an exemplary three-dimensional sensor provided by an embodiment of the disclosure. As shown in FIG. 4, in the embodiment of the disclosure, the two-dimensional image data of the game table acquired by the two-dimensional sensor is only two-dimensional plane data, human body detection information may be detected from the two-dimensional image data, specifically, including detection information of a player 1 and a player 2 around the game table, in practice, only detection information of players close to the game table is needed, however, the distance between the detected player 1 and the game table and the distance between the player 2 and the game table may not be known from the two-dimensional image data, and therefore, three-dimensional scene data obtained by the three-dimensional sensor may be used for determining the distance between the player 1 and the game table and the distance between the player 2 and the game table, so that the detection information of the player 2 may be filtered from the human body detection information.

The embodiments of the disclosure provide the method for detecting the human body around the game table. The method includes that: three-dimensional scene data of the game table collected by at least one three-dimensional sensor arranged around the game table is acquired; human body detection information around the game table is acquired, and the human body detection information includes detection information of at least one human body; and the human body detection information is filtered based on the three-dimensional scene data to obtain a human body detection result around the game table. According to the embodiments of the disclosure, the three-dimensional scene data of the game table in the game scene is acquired by using the three-dimensional sensor, and the human body detection information around the game table is filtered, so that the accurate and effective human body detection result is obtained.

The embodiments of the disclosure provide an apparatus for detecting a human body around a game table. FIG. 5 illustrates a structural schematic diagram an apparatus for detecting a human body around a game table provided by an embodiment of the disclosure. As shown in FIG. 5, the apparatus for detecting a human body around a game table includes an acquisition module 501 and a detection module 502.

The acquisition module 501 is configured to acquire three-dimensional scene data of the game table collected by at least one three-dimensional sensor arranged around the game table, and acquire human body detection information around the game table, where the human body detection information includes detection information of at least one human body.

The detection module 502 is configured to filter the human body detection information based on the three-dimensional scene data to obtain a human body detection result around the game table.

In an embodiment of the disclosure, the detection module 502 is specifically configured to determine the distance between each detected human body in the human body detection information and the game table based on the three-dimensional scene data, and filter the human body detection information at a distance exceeding a set threshold value from the game table in the human body detection information to obtain the human body detection result around the game table.

In an embodiment of the disclosure, the acquisition module 501 is specifically configured to acquire two-dimensional image data of the game table collected by at least one two-dimensional image sensor arranged around the game table, and detect the human body around the game table based on the two-dimensional image data to obtain two-dimensional human body detection information around the game table.

In an embodiment of the disclosure, the number of the three-dimensional sensor arranged round the game table is 1, and the three-dimensional scene data includes depth information.

The detection module 502 is specifically configured to determine depth information of the game table and each human body in the two-dimensional human body detection information based on the three-dimensional scene data, and determine the distance between each human body in the two-dimensional human body detection information and the game table based on the depth information.

In an embodiment of the disclosure, the apparatus for detecting a human body around a game table further includes a construction module (not shown in the figure), the at least one three-dimensional sensor refers to a plurality of three-dimensional sensors, and the plurality of three-dimensional sensors is distributed at a plurality of different orientations around the game table.

The construction module is configured to construct complete three-dimensional data of the game table based on the three-dimensional scene data of the game table collected by each three-dimensional sensor in the plurality of three-dimensional sensors.

The acquisition module 501 is specifically configured to carry out human body detection based on the complete three-dimensional data of the game table to obtain three-dimensional human body detection information around the game table.

In an embodiment of the disclosure, the detection module 502 is further configured to carry out game prop detection based on the complete three-dimensional data to obtain three-dimensional detection information of a game prop on the game table, and determine an operation relationship between the human body and the game props based on the three-dimensional detection information of the game prop and the three-dimensional human body detection information.

In an embodiment of the disclosure, the acquisition module 501 is further configured to acquire two-dimensional image data of the game table collected by at least one two-dimensional image sensor arranged around the game table.

The detection module 502 is further configured to detect the human body around the game table and the game prop on the game table based on the two-dimensional image data to obtain two-dimensional human body detection information around the game table and two-dimensional detection information of the game prop on the game table.

In an embodiment of the disclosure, the detection module 502 is specifically configured to fuse the two-dimensional human body detection information and the three-dimensional human body detection information to obtain multi-mode human body detection information, fuse the two-dimensional detection information and the three-dimensional detection information of the game prop to obtain multi-mode detection information of the game prop, and determine the operation relationship between the human body and the game prop based on the multi-mode human body detection information and the multi-mode detection information of the game prop.

In an embodiment of the disclosure, the detection module 502 is specifically configured to determine a first operation relationship between the human body and the game prop in a two-dimensional plane based on the two-dimensional human body detection information and the two-dimensional detection information of the game prop, determine a second operation relationship between the human body and the game prop in a three-dimensional space based on the three-dimensional human body detection information and the three-dimensional detection information of the game prop, and fuse the first operation relationship and the second operation relationship to obtain the operation relationship between the human body and the game prop.

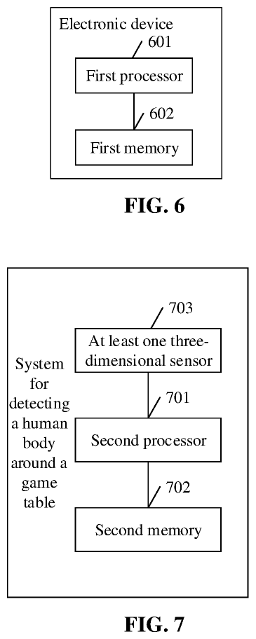

The embodiments of the disclosure provide an electronic device. FIG. 6 illustrates a structural schematic diagram of an electronic device provided by an embodiment of the disclosure. As shown in FIG. 6, in the embodiment of the disclosure, the electronic device includes: a first processor 601 and a first memory 602. The first memory 602 stores a computer program executable on the first processor 601. When the first processor 601 implements the program, the method for detecting a human body around a game table is implemented.

The embodiments of the disclosure provide a system for detecting a human body around a game table. FIG. 7 illustrates a structural schematic diagram of a system for detecting a human body around a game table provided by an embodiment of the disclosure. As shown in FIG. 7, the system for detecting a human body around a game table includes: a second processor 701, a second memory 702, and at least one three-dimensional sensor 703 arranged around the game table.

The at least one three-dimensional sensor 703 is configured to collect three-dimensional scene data of the game table.

The second processor 701 is configured to execute one or more programs stored in the second memory 702, to implement the following steps: human body detection information around the game table is acquired, and the human body detection information includes detection information of at least one human body; and the human body detection information is filtered based on the three-dimensional scene data to obtain a human body detection result around the game table.

In an embodiment of the disclosure, the system further includes at least one two-dimensional image sensor (not shown in the figure) arranged around the game table.

The at least one two-dimensional image sensor is configured to collect two-dimensional image data of the game table.

The second processor 701 is specifically configured to detect the human body around the game table based on the two-dimensional image data to obtain two-dimensional human body detection information around the game table.

The embodiments of the disclosure provide a computer-readable storage medium, storing one or more programs; and the one or more programs may be executed by one or more processors, to implement the method for detecting a human body around a game table. The computer-readable storage medium may be a volatile memory such as a Random-Access Memory (RAM), or a non-volatile memory such as a Read-Only Memory (ROM), a flash memory, a Hard Disk Drive (HDD) or a Solid-State Drive (SSD), or may also be a device including any one or combination of the above memories, such as a mobile phone, a computer, a tablet and a PDA.

Those skilled in the art should understand that the embodiments of the disclosure can provide a method, a system or a computer program product. Thus, forms of hardware embodiments, software embodiments or embodiments integrating software and hardware can be adopted in the disclosure. Moreover, a form of the computer program product implemented on one or more computer available storage media (including, but not limited to, a disk memory, an optical memory and the like) containing computer available program codes can be adopted in the disclosure.

The disclosure is described with reference to flowcharts and/or block diagrams of the method, the device (system) and the computer program product according to the embodiments of the disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions assigned in one or more flows of the flowcharts and/or one or more blocks of the block diagrams is generated via instructions executed by the computers or the processors of the other programmable data processing devices.

These computer program instructions can also be stored in a computer readable memory capable of guiding the computers or the other programmable data processing devices to work in a specific mode, so that a manufactured product including an instruction apparatus is generated via the instructions stored in the computer readable memory, and the instruction apparatus realizes the functions assigned in one or more flows of the flowcharts and/or one or more blocks of the block diagrams.

These computer program instructions can also be loaded to the computers or the other programmable data processing devices, so that processing realized by the computers is generated by executing a series of operation steps on the computers or the other programmable devices, and therefore the instructions executed on the computers or the other programmable devices provide a step of realizing the functions assigned in one or more flows of the flowcharts and/or one or more blocks of the block diagrams.

The above are merely some embodiments of the disclosure, rather than a limit to the protection scope of the disclosure.

What is claimed is:

1. A method for detecting a human body around a game table, comprising:
acquiring three-dimensional scene data of the game table collected by at least one three-dimensional sensor arranged around the game table;
acquiring human body detection information around the game table, wherein the human body detection information comprises detection information of at least one human body; and
filtering the human body detection information based on the three-dimensional scene data to obtain a human body detection result around the game table.

2. The method of claim 1, wherein filtering the human body detection information based on the three-dimensional scene data to obtain the human body detection result around the game table comprises:
determining a distance between each detected human body in the human body detection information and the game table based on the three-dimensional scene data; and
filtering the human body detection information at a distance exceeding a set threshold value from the game table in the human body detection information to obtain the human body detection result around the game table.

3. The method of claim 2, wherein acquiring the human body detection information around the game table comprises:
acquiring two-dimensional image data of the game table collected by at least one two-dimensional image sensor arranged around the game table; and
detecting the human body around the game table based on the two-dimensional image data to obtain two-dimensional human body detection information around the game table.

4. The method of claim 3, wherein the number of the three-dimensional sensor arranged round the game table is 1, and the three-dimensional scene data comprises depth information; wherein determining the distance between each detected human body in the human body detection information and the game table based on the three-dimensional scene data comprises:
determining depth information of the game table and each human body in the two-dimensional human body detection information based on the three-dimensional scene data; and
determining the distance between each human body in the human body detection information and the game table based on the depth information.

5. The method of claim 1, wherein the at least one three-dimensional sensor refers to a plurality of three-dimensional sensors, and the plurality of three-dimensional sensors is distributed at a plurality of different orientations around the game table;
wherein the method further comprises:
constructing complete three-dimensional data of the game table based on the three-dimensional scene data of the game table collected by each three-dimensional sensor in the plurality of three-dimensional sensors;
wherein acquiring the human body detection information around the game table comprises:
carrying out human body detection based on the complete three-dimensional data of the game table to obtain three-dimensional human body detection information around the game table.

6. The method of claim 5, wherein the method further comprises:
carrying out game prop detection based on the complete three-dimensional data to obtain three-dimensional detection information of a game prop on the game table; and
determining an operation relationship between the human body and the game prop based on the three-dimensional detection information of the game prop and the three-dimensional human body detection information.

7. The method of claim 6, wherein the method further comprises:
acquiring two-dimensional image data of a game table collected by at least one two-dimensional image sensor arranged around the game table; and
detecting the human body around the game table and the game prop on the game table based on the two-dimensional image data to obtain two-dimensional human body detection information around the game table and two-dimensional detection information of the game prop on the game table.

8. The method of claim 7, wherein determining the operation relationship between the human body and the game prop based on the three-dimensional detection information of the game prop and the three-dimensional human body detection information comprises:
fusing the two-dimensional human body detection information and the three-dimensional human body detection information to obtain multi-mode human body detection information;
fusing the two-dimensional detection information and the three-dimensional detection information of the game prop to obtain multi-mode detection information of the game prop; and
determining the operation relationship between the human body and the game prop based on the multi-mode human body detection information and the multi-mode detection information of the game prop.

9. The method of claim 7, wherein determining the operation relationship between the human body and the game prop based on the three-dimensional detection information of the game prop and the three-dimensional human body detection information comprises:
determining a first operation relationship between the human body and the game prop in a two-dimensional plane based on the two-dimensional human body detection information and the two-dimensional detection information of the game prop;
determining a second operation relationship between the human body and the game prop in a three-dimensional space based on the three-dimensional human body detection information and the three-dimensional detection information of the game prop; and
fusing the first operation relationship and the second operation relationship to obtain the operation relationship between the human body and the game prop.

10. An electronic device, comprising a first processor and a first memory, wherein the first memory stores a computer program executable on the first processor, wherein when executing the computer program, the first processor is configured to:
acquire three-dimensional scene data of the game table collected by at least one three-dimensional sensor arranged around the game table;
acquire human body detection information around the game table, wherein the human body detection information comprises detection information of at least one human body; and
filter the human body detection information based on the three-dimensional scene data to obtain a human body detection result around the game table.

11. The electronic device of claim 10, wherein when filtering the human body detection information based on the three-dimensional scene data to obtain the human body detection result around the game table, the first processor is configured to:
determine a distance between each detected human body in the human body detection information and the game table based on the three-dimensional scene data; and
filter the human body detection information at a distance exceeding a set threshold value from the game table in the human body detection information to obtain the human body detection result around the game table.

12. The electronic device of claim 11, wherein when acquiring the human body detection information around the game table, the first processor is configured to:
acquire two-dimensional image data of the game table collected by at least one two-dimensional image sensor arranged around the game table; and
detect the human body around the game table based on the two-dimensional image data to obtain two-dimensional human body detection information around the game table.

13. The electronic device of claim 12, wherein the number of the three-dimensional sensor arranged round the game table is 1, and the three-dimensional scene data comprises depth information;
wherein when determining the distance between each detected human body in the human body detection information and the game table based on the three-dimensional scene data, the first processor is configured to:
determining depth information of the game table and each human body in the two-dimensional human body detection information based on the three-dimensional scene data; and
determining the distance between each human body in the human body detection information and the game table based on the depth information.

14. The electronic device of claim 10, wherein the at least one three-dimensional sensor refers to a plurality of three-dimensional sensors, and the plurality of three-dimensional sensors is distributed at a plurality of different orientations around the game table;
wherein the first processor is further configured to:
construct complete three-dimensional data of the game table based on the three-dimensional scene data of the game table collected by each three-dimensional sensor in the plurality of three-dimensional sensors;
wherein when acquiring the human body detection information around the game table, the first processor is configured to:
carry out human body detection based on the complete three-dimensional data of the game table to obtain three-dimensional human body detection information around the game table.

15. The electronic device of claim 14, wherein the first processor is further configured to:
carry out game prop detection based on the complete three-dimensional data to obtain three-dimensional detection information of a game prop on the game table; and
determine an operation relationship between the human body and the game prop based on the three-dimensional detection information of the game prop and the three-dimensional human body detection information.

16. The electronic device of claim 15, wherein the first processor is further configured to:
acquire two-dimensional image data of the game table collected by at least one two-dimensional image sensor arranged around the game table; and
detect the human body around the game table and the game prop on the game table based on the two-dimensional image data to obtain two-dimensional human body detection information around the game table and two-dimensional detection information of the game prop on the game table.

17. The electronic device of claim 16, wherein when determining the operation relationship between the human body and the game prop based on the three-dimensional detection information of the game prop and the three-dimensional human body detection information, the first processor is configured to:
fuse the two-dimensional human body detection information and the three-dimensional human body detection information to obtain multi-mode human body detection information;
fuse the two-dimensional detection information and the three-dimensional detection information of the game prop to obtain multi-mode detection information of the game prop; and
determine the operation relationship between the human body and the game prop based on the multi-mode human body detection information and the multi-mode detection information of the game prop.

18. The electronic device of claim 16, wherein when determining the operation relationship between the human body and the game prop based on the three-dimensional detection information of the game prop and the three-dimensional human body detection information, the first processor is configured to:
determine a first operation relationship between the human body and the game prop in a two-dimensional plane based on the two-dimensional human body detection information and the two-dimensional detection information of the game prop;
determine a second operation relationship between the human body and the game prop in a three-dimensional space based on the three-dimensional human body detection information and the three-dimensional detection information of the game prop; and
fuse the first operation relationship and the second operation relationship to obtain the operation relationship between the human body and the game prop.

19. A nonvolatile computer-readable storage medium, storing at least one program; wherein the at least one program is executed by at least one program to:
acquire three-dimensional scene data of a game table collected by at least one three-dimensional sensor arranged around the game table;
acquire human body detection information around the game table, wherein the human body detection information comprises detection information of at least one human body; and
filter the human body detection information based on the three-dimensional scene data to obtain a human body detection result around the game table.
